(19) United States
(12) Patent Application Publication
(10) Pub. No.: US 2021/0164071 A1
(43) Pub. Date: Jun. 3, 2021

(54) TEMPERATURE-CONTROL DEVICE FOR PARTIALLY COOLING A COMPONENT

(71) Applicant: SCHWARTZ GMBH, Simmerath (DE)

(72) Inventors: Frank Wilden, Simmerath (DE); Jörg Winkel, Nideggen-Schmidt (DE); Andreas Reinartz, Monschau (DE)

(21) Appl. No.: 17/047,188

(22) PCT Filed: Apr. 5, 2019
(86) PCT No.: PCT/EP2019/058599

§ 371 Date: Oct. 13, 2020

(30) Foreign Application Priority Data
Apr. 20, 2018 (DE) 10 2018 109 579.1

(51) Int. Cl. C21D 9/573; C21D 1/667

(52) U.S. Cl. CPC C21D 9/5732; C21D 1/613; C21D 1/667; C21D 9/5735

(57) ABSTRACT

The invention relates to a temperature-control device for partially cooling a component, wherein the component is blown on with a fluid in the region to be cooled by means of a nozzle. The nozzle comprises a connecting tube which is connected to a fluid reservoir in a fluid-conducting manner and which is connected to a plurality of nozzle tubes in a fluid-conducting manner

The invention relates to a temperature-control device for partially cooling a component, wherein the temperature-control device has at least one nozzle which has for discharging a fluid flow for cooling at least a partial region of the component. The nozzle comprises a connecting tube for supplying the fluid from a reservoir and a plurality of nozzle tubes. The nozzle according to the invention can in particular be used in a press hardening line in which a press hardening tool is arranged downstream of a continuous furnace, wherein the continuous furnace can in particular be a roller hearth furnace.

When producing sheet steel parts, it is often necessary to harden the sheet steel during or after a forming process. Such a sheet steel part can for example be a body panel of a motor vehicle. A heat treatment process, which is referred to as press hardening, can be used for the production of such sheet steel parts. In this process, the steel sheet is heated in a furnace and then reshaped in a press and cooled and thereby hardened.

For different applications, it is desirable to produce components that have different strengths in different regions. For example, the central region of a B-pillar of a motor vehicle should have high strength to protect the vehicle occupants as well as possible in the event of a side impact. By means of press hardening, there is the possibility of producing body components of motor vehicles, such as A-pillars or B-pillars and side impact protection supports in doors or frame parts, which are designed accordingly.

Some regions of such a component, on the other hand, should have a lower strength in order, on the one hand, to be able to absorb deformation energy in the event of an impact. On the other hand, regions of this type have more favorable properties in terms of connectivity to other body panels.

The different strength regions of such a component can be brought about by targeted cooling. Those regions which are supposed to have a lower strength with a higher ductility can be cooled in a targeted manner, while other regions which have a higher strength with a lower ductility can be kept warm. Such targeted cooling of a region of a component can be achieved by blowing a fluid onto the region, wherein the fluid has a lower temperature than the starting temperature of the component. The target temperature of such a region depends on the one hand on the original temperature of the component, the temperature of the fluid and the duration of the blowing and the fluid pressure, wherein the known laws of thermodynamics apply. This process for producing different hardness regions in a component by targeted cooling of at least one region is also known as “thermal printing.”

A component's regions of different hardnesses should be geometrically limited as precisely as possible. Accordingly, it is necessary to set the cooling of the regions in a geometrically precise manner A fluid jet may therefore only blow onto that region of a component that is to be cooled. Adjacent regions of the component should not be cooled by the fluid flow.

Known nozzles for blowing on components in corresponding temperature-control devices are known, but have the disadvantage of being expensive due to the high thermal and mechanical stress and have a very short service life or only allow a blurred transition between the region to be cooled and an adjacent region. In conventional temperature-control devices, correspondingly expensive nozzles have been used or the nozzles used have only provided a blurred distinction between the region to be blown on and an adjacent region. In the latter case, partitions or bulkheads have often been used to prevent the cooling fluid from flowing over to adjacent regions. The disadvantage of such bulkheads, however, is that they should come as close as possible to the surface of the component in order to achieve good sealing of the region to be cooled on the one hand, but on the other hand the bulkhead should not touch the component.

The object of this invention is to provide a nozzle that is suitable for precisely blowing on a region of a component, or a corresponding temperature-control device, which should at the same time be inexpensive to produce.

This object is achieved by a nozzle described below or a temperature-control device appropriately equipped with said nozzle. Advantageous further developments of the device are defined in the dependent claims.

### BRIEF DESCRIPTION OF THE DRAWINGS

The drawings described below are neither true to scale nor do they reproduce all details of the invention described. In the drawings:

FIG. 1 is a schematic side view of a temperature-control device with a strip nozzle,

FIG. 2 is a schematic front view of a first embodiment of a strip nozzle,

FIG. 3 is a schematic front view of a second embodiment of a strip nozzle,

FIG. 4 is a schematic thermographic image of a region cooled by means of a strip nozzle.

### DESCRIPTION

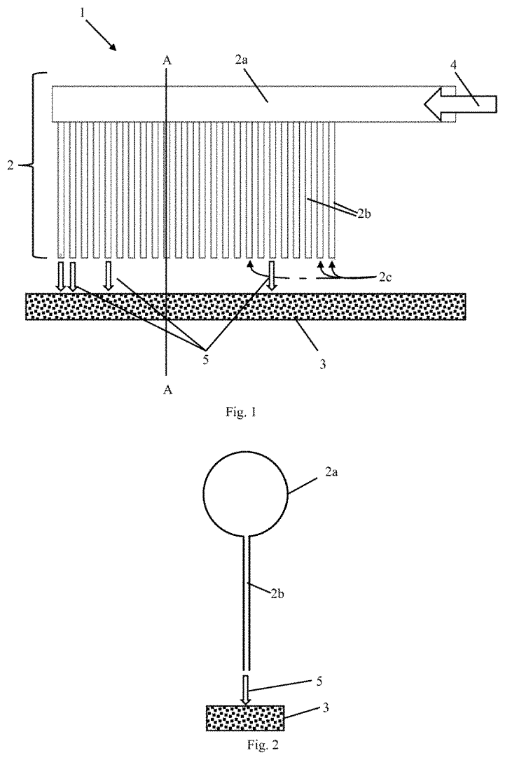

FIG. 1 shows a strip nozzle 2 of a temperature-control device 1 which blows on a heated component 3 in at least one partial region with a fluid flow in order to cool the component in the blown region.

The component 3 can be in the form of a sheet, in particular as a steel sheet or another sheet, which has been heated before cooling. For this purpose, the component can have passed through a furnace, for example a so-called continuous furnace, in particular a roller hearth furnace or a chamber furnace, in particular a multi-chamber furnace, or the like. In the furnace, the component is typically heated in such a way that it essentially is of the same temperature in all regions.

The heated component is then fed to the temperature-control device 1, which blows a cold fluid onto the component 3 at least in a partial region so that the blown region of the component is cooled by the impinging fluid flow. The feeding of the component can include a further conveyance of the heated component 3 from the furnace to a temperature-control station which comprises the temperature-control device, i.e. the heated component can in one embodiment be guided from the furnace into the temperature-control device, for example via a roller belt.

In an alternative embodiment, the temperature-control device can be an integral part of a further processing or machining unit, for example a furnace. For this purpose, the temperature-control device can be arranged in a region of a furnace so that all regions of the component 3 are initially heated in the furnace and then at least a partial region of the component is cooled by means of the temperature-control device 1 and in particular by means of a strip nozzle.

All embodiments of the strip nozzle have in common that they have a connecting tube 2a, which is connected to a plurality of nozzle tubes 2b in a fluid-conducting manner, i.e. each nozzle tube 2b is fixed at one end, its inlet end, to the connecting tube 2a and is connected to it there in such a way that fluid can flow from the connecting tube 2a into the nozzle tube 2b. Typically, but not necessarily, the connecting tube 2a is arranged horizontally and the nozzle tubes are vertical with their outlet end directed downwards in order to partially cool a hot component 3 underneath. The nozzle tubes 2b are arranged in such a way that their blow-out openings 2c are arranged close to one another and in a line. The arrangement of the blow-out openings close to one another means that the fluid flows emerging from the blow-out openings impinge on the surface of the component 3 in close proximity to one another, so that the impact surfaces of the fluid flows of two adjacent outlet tubes merge into one another and thus almost the same cooling effect is brought about at the boundary line to a non-blown surface portion of the component as in the core impact surface of the fluid flow of a nozzle tube 2b. The nozzle tubes are thus designed and aligned in their blow-out direction so that the plurality of core impact surfaces of the fluid flows result in a strip, the width of which is determined by the diameter of the blow-out opening of a nozzle tube and the length of which is essentially determined by the number and width of the nozzle tubes 2b arranged next to one another, see the description of FIG. 4.

The connecting tube 2a is connected to a tank in which the fluid used for cooling is temporarily stored. The fluid thus flows from the tank, not shown in the drawing, through the connecting tube 2a into the plurality of nozzle tubes 2b and flows out of the outlet openings of the nozzle tubes onto the surface of the component 3. The fluid flow from the tank into the connecting tube 2a of the strip nozzle 2 is shown schematically in the drawing with the arrow 4. The tank can typically be a pressurized volume, for example a storage container or pressure tank, from which fluid is withdrawn via the connecting tube 2a while the component 3 is being blown on. In a particular embodiment, the storage container or the pressure tank can be cooled and set to a specific temperature so that the fluid removed is of a desired temperature which is suitable for cooling the component.

The fluid flows from the connecting tube 2a into each nozzle tube 2b and leaves the respective nozzle tube through its blow-out opening 2c , so that a plurality of individual flows corresponding to the number of nozzle tubes leaves the strip nozzle 2. The plurality of individual fluid flows is shown schematically in the drawing with arrows 5.

The flow cross-section of the connecting tube 2a is preferably a multiple of the sum of the flow cross-sections with the nozzle tubes connected to this connecting tube in a fluid-conducting manner In a preferred embodiment, the flow cross-section of the connecting tube is at least twice the sum of the flow cross-sections of the nozzle tubes 2b, and in particular at least three times the sum of the flow cross-sections of the nozzle tubes 2b.

The length of the nozzle tubes is selected so that they are essentially the same length, so that the exiting volume flow of fluid is essentially the same, wherein the length of a nozzle tube is at least 10 times, particularly preferably at least 20 times and in particular approximately 40 times the inner diameter of a nozzle tube or even more than 40 times.

The length of the nozzle tubes in relation to the diameter causes a large flow resistance in each nozzle tube. This reacts to the fluid pressure in the connecting tube and causes a static pressure to build up there which is constant over the length of the connecting tube. This results in a very uniform distribution of the volume flow over all nozzle tubes 2b and thus uniform cooling over the entire length of the blown surface.

The distance between the nozzle tubes and the outflow direction of the individual fluid flows is selected in such a way that the blown surface of the component 3 has the shape of an uninterrupted strip.

In one embodiment, the nozzle tubes are in any case arranged parallel to one another in their last portion, which defines the outflow direction of a fluid flow, so that the individual fluid flows 5 are also aligned parallel to one another. In alternative embodiments, the nozzle tubes can also be aligned non-parallel, but in such a way that the fluid flows 5 seamlessly hit one another when they hit the surface of the component and thus the desired strip or flat shape of the cooled surface is achieved.

The distance between two adjacent nozzle tubes 2b is selected so that the individual flows of fluid blown out on the component surface produce the desired strip or surface shape and uniform cooling over the extension of the entire blown surface. It could be confirmed in tests that the nozzle tubes do not have to be arranged as close to one another as possible, in particular not adjacent to one another, in order to obtain a temperature curve that is almost constant over the length of the blown surface. Typically, the center-to-center distance of the outlet openings of adjacent nozzle tubes 2b is twice to 20 times the inner diameter of a nozzle tube 2b, particularly preferably 3 to 10 times and in particular 4 to 5 times the inner diameter of a nozzle tube 2b, wherein it is assumed that the wall thickness of a nozzle tube is less than a quarter of the inner diameter of a nozzle tube 2b.

The outlet openings of the nozzle tubes can be circular in one embodiment, in particular if the respective nozzle tube itself has a circular cross-sectional shape. In alternative embodiments, an outlet opening can have an oval shape, wherein the oval outlet opening is molded onto an otherwise circular nozzle tube and the long axis of the oval outlet opening is arranged in the direction of the desired strip shape of the blown surface. In this way, the design of the outlet opening can be used to shape the blown surface. In further alternative embodiments, an outlet opening can have an oval, angular, in particular a quadrangular shape, and particularly preferably a rectangle with sides of unequal length, wherein the long sides can be arranged in the direction of the desired cooling strip. In further alternative embodiments, the outlet openings can have other shapes, for example triangular, or different shapes of the outlet openings can also be combined in order to achieve a desired shape of the blown surface. For example, at the end of a row of nozzle tubes, the outlet opening of the last nozzle tube can have a different shape than the nozzle tubes which are arranged between the last nozzle tubes, so that a desired shape of the end of the blown surface is achieved with the shape of the last outlet opening.

The distance of the blow-out openings 2c from the surface of the component 3 is selected so that the fluid flow impinging on the surface of the component 3 is sharply contoured. The distance between the blow-out openings 2c and the surface of the component 3 is typically a few millimeters, preferably 5 mm to 100 mm, preferably 10 mm to 80 mm

FIG. 2 shows a section through a strip nozzle along the line A-A in FIG. 1, i.e. through the connecting tube 2a and a nozzle tube 2b. At its inlet end, the nozzle tube connects to the connecting tube 2a in a fluid-conducting manner and guides the fluid in a straight line to the component 3. The nozzle tube 2b can have one of the above-mentioned cross-sectional regions; likewise, the connecting tube 2a can have a round cross-sectional region or, alternatively, an oval or angular cross-sectional region.

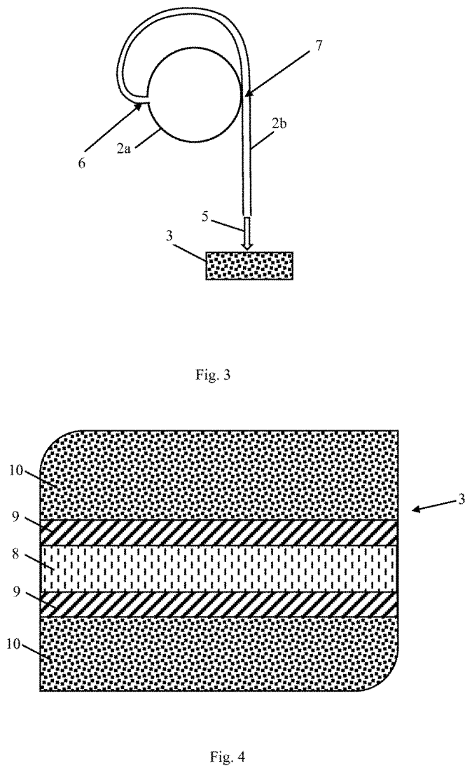

FIG. 3 shows a section through a strip nozzle with a nozzle tube 2b which is not designed in a straight line as in FIG. 2a, but which is fixed next to the fluid-conducting connection at least at a second point 7 of the nozzle tube. As shown in the drawing, the nozzle tube 2b can be guided circumferentially around the connecting tube 2a in an arc and can be fixed at the second point 7 directly to the connecting tube 2a, for example by a positively locking or bonded connection, for example a weld point. By guiding the nozzle tube 2b around the connecting tube by at least 180°, here in the drawing by approx. 270°, the overall height can be reduced compared to the design shown in FIG. 1 or FIG. 2. Only the free end of a nozzle tube 2b, i.e. the portion from the second fixing point 7 to the outlet end, is then preferably designed as a straight tube.

Furthermore, the length of the free end of the nozzle tube 2b, i.e. the length from the outlet end to the closest fixing point of the nozzle tube, is smaller than in the design shown in FIG. 1 or FIG. 2, so that, as a result of the shorter free tube length, the nozzle tube is less susceptible to vibrations or other influences that can arise from the fluid flows in the temperature-control device.

In an alternative embodiment, the nozzle tubes 2b with the second fixing point can also be fixed indirectly to the connecting tube 2a or another element of the temperature-control device. For example, several nozzle tubes can be guided through an auxiliary sheet (not shown in the drawing) and fixed on said auxiliary sheet, so that the nozzle tubes are fixed directly on the auxiliary sheet. The auxiliary sheet can in turn be fixed directly to the connecting tube 2a or to another element of the temperature-control device.

In one embodiment, all nozzle tubes can be connected to the connecting tube 2a in a fluid-conducting manner on the same side, as shown in FIG. 3, for example on the left-hand side. As an alternative to this, the nozzle tubes can alternately be connected and fixed in a fluid-conducting manner on opposite sides, wherein the nozzle tubes are then aligned in such a way that the blown fluid flows 5 on the surface to be blown on produce the desired strip shape.

In further alternative embodiments, the nozzle tubes can also be connected to the connecting tube at the top or bottom and then guided around the connecting tube in an arc of approximately 180° or 360°.

FIG. 4 shows a thermography of a component which, during a measurement by means of a strip nozzle, was blown on with cold, gaseous fluid, here with cold air. The nozzle tubes of the strip nozzle were designed as straight tubes, fixed to the underside of a connecting tube in a fluid-conducting manner, and which have a uniform length of approx. 20 cm and a uniform inner diameter of approx. 4 mm with a circular outlet opening, so that the core jet of the fluid has a diameter of 4 mm The outlet openings were placed at a distance of approx. 30 mm below the outlet openings of the nozzle tubes. The cold, gaseous fluid was then blown onto the steel sheet, which had been heated to approx. 850° C., for a few seconds, wherein the fluid was forced into the connecting tube at a pressure of approx. 3.5 bar.

The thermography shows the heat distribution shown schematically in FIG. 4. The temperature of the component 3 was reduced by approx. 200° C. in a strip-shaped surface 8 of approx. 20 mm, wherein this geometrically followed the course of the nozzle. Along the strip-shaped blown region, a transition region 9 could be measured, in which the temperature increases sharply in the direction of the non-blown region.

A further measurement was carried out with a strip nozzle which had a plurality of nozzle tubes with a uniform inner diameter of 4 mm, a wall thickness of 1 mm and a nozzle tube length of 100 mm The outlet openings of the nozzle tubes were arranged approx. 100 mm above the surface of the component 3 to be blown on. The determined thermography showed the desired sharp contouring of the blown surface.

In further series of measurements, it could be shown that shorter nozzle tubes with this inner diameter produce a similarly sharp contouring, but lead to significantly higher noise emissions. For considerably longer nozzle tubes, no improvement in the accuracy of the blown surface could be determined. Rather, nozzle tubes that are very long in relation to their inner diameter tend to produce undesirable instabilities and vibrations.

In comparison with blowing with conventional nozzles, it has been shown on the one hand that the blown surface 8 that can be achieved with the strip nozzle is sharply contoured and a uniform temperature distribution can be achieved in the direction of the long side of the strip, although the nozzle openings have separate and spatially separated fluid jets. Furthermore, it could be shown that when using the strip nozzle, an overall lower volume flow of fluid compared to conventional nozzles is sufficient to achieve the same cooling effect, so that the strip nozzle can be used more efficiently. Furthermore, this also results in lower noise emissions.

In one embodiment of a temperature-control device, several strip nozzles 2 can be arranged next to one another and/or one behind the other for cooling a component 3. The cooling air nozzles can be designed differently, in particular they can be set up and designed in such a way that different fluid flow volumes with different geometrical dimensions are provided so that a component can be cooled differently in different, possibly adjacent regions. In this way, different regions of a component can be cooled at the same time but differently, i.e. thermally “printed.”

### LIST OF REFERENCE SIGNS

1 Temperature-control device
2 Strip nozzle
2a Connecting tube
2b Nozzle tubes
2c Blow-out opening, outlet end
3 Component
4 Arrow (fluid flow)
5 (Individual) fluid flow
6 Fluid-conducting connection/fixing
7 Second fixing point
8 Strip-shaped blown surface
9 Transition region
10 Non-blown region

1. Temperature-control device for partially cooling a component, wherein said temperature-control device comprises a nozzle which has for discharging a fluid flow for cooling at least a partial region of the component, and wherein the nozzle has a connecting tube for supplying the fluid from a reservoir and a plurality of nozzle tubes for discharging the fluid, wherein the nozzle tubes are connected to the connecting tube in a fluid-conducting manner at their inlet end and the cross-sectional region of the connecting tube is at least twice as large as the sum of the cross-sectional regions of the nozzle tubes, and wherein the respective length of a nozzle tube is at least 10 times the respective inner diameter, and wherein the center-to-center distance of the outlet openings of adjacent nozzle tubes is 1.5 to 20 times the inner diameter of a nozzle tube.

2. Temperature-control device according to claim 1, wherein the nozzle tubes are each fixed with a further fixing point spaced from the inlet end.

3. Temperature-control device according to claim 2, wherein the nozzle tubes are each at least partially guided circumferentially around the connecting tube and are fixed to the connecting tube with the further fixing point spaced from the inlet end.

4. Temperature-control device according to claim 3, wherein the nozzle tubes are each guided circumferentially around the connecting tube by at least 180°.

5. Temperature-control device according to 4 claim 2, wherein the nozzle tubes are straight in the respective portion between the second fixing point and the outlet end.

6. Temperature-control device according to claim 2, wherein the outlet end of at least one nozzle tube has a non-circular cross-sectional shape.

7. Temperature-control device according to claim 1, wherein the nozzle tubes are arranged in parallel.

8. Temperature-control device according to claim 2, wherein the nozzle tubes are arranged alternately on opposite sides of the connecting tube.

9. Temperature-control device according to claim 1, wherein the nozzle tubes are of the same length.

10. Temperature-control device according to claim 1, wherein the outlet openings of the nozzle tubes have a round cross-section.

11. Temperature-control device according to claim 3, wherein the nozzle tubes are straight in the respective portion between the second fixing point and the outlet end.

12. Temperature-control device according to claim 4, wherein the nozzle tubes are straight in the respective portion between the second fixing point and the outlet end.

13. Temperature-control device according to claim 3, wherein the outlet end of at least one nozzle tube has a non-circular cross-sectional shape.

14. Temperature-control device according to claim 4, wherein the outlet end of at least one nozzle tube has a non-circular cross-sectional shape.

15. Temperature-control device according to claim 5, wherein the outlet end of at least one nozzle tube has a non-circular cross-sectional shape.

16. Temperature-control device according to claim 2, wherein the nozzle tubes are arranged in parallel.

17. Temperature-control device according to claim 3, wherein the nozzle tubes are arranged in parallel.

18. Temperature-control device according to claim 3, wherein the nozzle tubes are arranged alternately on opposite sides of the connecting tube.

19. Temperature-control device according to claim 2, wherein the nozzle tubes are of the same length.

20. Temperature-control device according to claim 2, wherein the outlet openings of the nozzle tubes have a round cross-section.
